(19) United States
(12) Patent Application Publication
(10) Pub. No.: US 2009/0150965 A1
(43) Pub. Date: Jun. 11, 2009

(54) INTERACTIVE APPLICATION FOR CYCLING AND OTHER SORTS ON TELEVISION

(75) Inventors: Michiel J. Christianen, Zundert (NL); Johannes H.M. Lemmers, Reek (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,761

(22) PCT Filed: Nov. 30, 2005
(86) PCT No.: PCT/IB05/53975

§ 371 Date: May 21, 2007

Related U.S. Application Data
(60) Provisional application No. 60/632,132, filed on Dec. 1, 2004.

(51) Int. Cl. G06K 9/00; H04N 7/16

(52) U.S. Cl. 725/135; 382/103

(57) ABSTRACT

An interactive television application allows a viewer to track the progress of participants (110) along a course (100) in a sports event. The location of the participants is tracked, such as by using a GPS device (160). Data is provided to the application to provide an on-screen display (310) of a graphic (700) that shows the distances of different points along the course and the locations of the participants. The graphic is updated to show changes in the locations. Information regarding the course, such as difficulty (500) elevation (500, 600, 700) and weather conditions (700) can also be displayed on-screen. The viewer may also select participants to follow, such that other participants are filtered out. Furthermore, different camera feeds (120, 150) are associated with the participants such that the viewer can elect to view the camera feed of a selected participant.

The invention relates generally to an application for viewing a sports event on television and, more particularly, to an application that allows the viewer to follow participants as they traverse a course.

Viewing of sports events on television, such as bicycling, motorcycling, car racing, marathons, cross country running or skiing, and the like is a popular past time. Such events are often conducted on a course that extends some distance, such as several kilometers, over varying terrain. The course may extend between different points, in stages, or in a complete circuit that returns the participants to the starting point. The Tour de France bicycle race is an example of an event in which cyclists traverse long distances over mountainous terrain. Television broadcasters have sought to entertain and inform viewers of such events by providing on-screen information that indicates the standing, e.g., first, second, third and so forth, of the participants and the time intervals separating the participants. Additionally, cameras are placed at fixed locations along the course as well as in moving vehicles that follow the participants to provide camera feeds of the event. Cameras can even by carried by the participants themselves or their vehicles to show their perspective of a course. However, while such techniques are helpful, they do not provide the viewer with a significant ability to interact with the event, or to learn important information regarding the course or the participants.

The present invention addresses the above and other issues by providing an interactive application that allows the viewer to follow participants as they traverse a course, and to learn important information regarding the course and the participants.

In one aspect of the invention, a method for providing an application on a television for tracking at least one participant along a course, includes: receiving first data at the application indicating locations of different points along the course, receiving tracking data at the application that is obtained by tracking a location of the at least one participant as the at least one participant traverses the course, displaying, on the television, via the application, a graphic showing the locations of the different points of the course based on the first data, and showing a location of the at least one participant on the course, based on the tracking data, and updating the graphic to show changes in the location of the at least one participant as the at least one participant traverses the course.

In another aspect of the invention, a method for providing an interactive application on a television for viewing participants along a course, includes: providing, to the interactive application, data from camera feeds of the participants as the participants traverse the course, and data for associating the camera feeds with the participants, receiving a command from a viewer of the television, via the interactive application, that identifies at least one of the participants, selecting, via the interactive application, at least one of the camera feeds associated with the at least one identified participant, responsive to the command, using the data for associating the camera feeds with the participants, and playing the at least one selected camera feed on the television.

In yet another aspect of the invention, a method for providing an interactive application on a television for tracking participants along a course, includes: receiving tracking data at the interactive application that is obtained by tracking locations of the participants as the participants traverse the course, displaying, on the television, via the interactive application, a graphic showing locations of the participants on the course, based on the tracking data, updating the graphic to show changes in the locations of the participants as the participants traverse the course, providing, to the interactive application, data from camera feeds of the participants as the participants traverse the course, and data for associating the camera feeds with the participants, receiving a command from a viewer of the television, via the interactive application, that identifies at least one of the participants, selecting, via the interactive application, at least one of the camera feeds that has a view of the at least one identified participant, responsive to the command, using the data for associating the camera feeds with the participants, and playing the at least one selected camera feed on the television together with the graphic.

Corresponding systems and program storage devices may also be provided.

### IN THE DRAWINGS:

In all the Figures, corresponding parts are referenced by the same reference numerals.

FIG. 1 illustrates a cyclist on a road course, where feeds from stationary and moving cameras are obtained, according to the invention;

FIG. 2 illustrates a multiplexer for multiplexing data from different camera feeds and additional data such as weather data, location data, and data for associating camera feeds with participants, according to the invention;

FIG. 3 illustrates a set-top box and a television for running an interactive application for displaying graphics and data from camera feeds, according to the invention;

FIG. 4 illustrates a menu of an interactive television application, according to the invention;

FIG. 5 illustrates a dynamic profile of an interactive television application, according to the invention;

FIG. 6 illustrates a gaps profile of an interactive television application, according to the invention; and

FIG. 7 illustrates a weather screen of an interactive television application, according to the invention.

Generally, the present invention provides an interactive application for television viewers of sports events in which participants traverse a course. The participants may traverse the course under their own power, such as by running, cycling or cross-country skiing, in a motorized vehicle, such as a car, motorcycle, or boat, for instance, or by other means, such as on horseback or dogsled. The concept can be used with unmanned vehicles or animals, as well. The invention is described in the context of a cycling contest on a road course for illustrative purposes only.

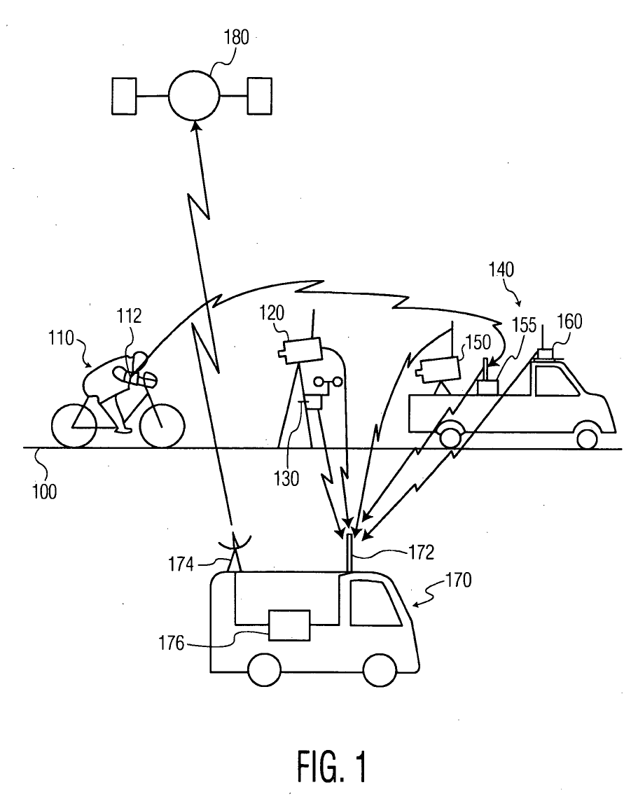

FIG. 1 illustrates a cyclist on a road course, where feeds from stationary and moving cameras are obtained, according to the invention. The course, a portion of which is shown generally at 100, can be mapped out before the event such as by obtaining data indicating the distances of different points along the course, e.g., with respect to the start of the course. Data regarding the elevation of the different points along the course can also be obtained. This data may be particularly interesting to the viewer when the course is hilly or mountainous. Such data may be available from databases that map the surface features of the earth. Or, a vehicle equipped with a location-measuring device and elevation/altitude-measuring device may drive the course to obtain the data. For example, a location-measuring device such as a global positioning satellite (GPS) receiver in the vehicle can be used to obtain data regarding the latitude and longitude of the different points on the course. The GPS receiver receives signals from three or more satellites to determine its location by triangulation. An altimeter in the vehicle can measure the elevation. Furthermore, the GPS and altitude data can be recorded to provide a set of data with coordinates of (position, elevation).

During the event, one or more participants traverse the course. For example, a participant 110 who is a cyclist may be one of many cyclists in a road race. Furthermore, different cameras may be provided to capture the event. Stationary cameras, an example of which is camera 120, may be positioned at different locations along the course. These cameras can be operated by a local human operator or by remote control, and may be attached to towers, secured in overhead balloons that provide a bird's eye view, and so forth. Moving cameras may also be provided. For example, a camera 150 is shown secured in the back of a vehicle 140 that traverses the course with the participant 110. Typically, a number of such vehicles are used to cover an event, and stay with a given participant or group of participants throughout the event. Furthermore, a location-measuring device 160, such as a GPS transceiver, may be carried by the participant, e.g., worn by the participant, or attached to the participant's bicycle or other vehicle, or by the camera vehicle 140. A weather station 130 is shown attached to a tower used by the stationary camera 120. A number of such weather stations may be positioned at different locations along the course to measure weather conditions such as cloud cover (clear, partly cloudy, cloudy) temperature, wind speed and direction, humidity, wind chill factor, precipitation, and the like.

The data obtained by the cameras 120 and 150, location measuring device 160, and weather station 130 can be gathered in different ways. In one possible approach, the cameras 120 and 150, location measuring device 160, and weather station 130 each include transmitters for transmitting respective wireless RF signals that can be received by an antenna 172 on a communications vehicle 170. One or more of such communications vehicles 170 can be positioned at various locations near the course as needed to receive the wireless signals. The communications vehicle 170 includes circuitry 176 for processing the received data in the wireless signals, e.g., by performing compression and coding, and providing a corresponding signal for transmission via an antenna 174 to a satellite 180, in one approach. The vehicle 170 may be manned by an operator that associates data with each moving and/or stationary camera feed to associate the cameras with the participant 110, and other participants, if present, in the field of view of the camera 120 or 150.

Essentially, an identifier can be provided for each participant, and the identifiers of the participants that are in the field of view of a given camera can be associated with the data feed from that camera. As mentioned, typically a given moving camera is associated with a given participant or group of participants. However, a moving camera may not be available for each participant, and participants may ride in groups and pass other participants. One way to handle this issue is to provide transmitters on each participant that transmits an identifier. For example, the participant 110 may wear a transmitter 112 on his arm, for instance, or attached to the bicycle, that transmits a signal to a transceiver 155 in the vehicle 140. The transceiver 155 transmits a signal with the identifiers of the participants, and an identifier of the camera 150, to the communications vehicle 170. In this way, it is always known which participants are in the field of view of a given moving camera. Note that the transmission range and direction of the transmitter 112 can be configured accordingly. The location data provided by the location measuring device 160 is updated as the location changes, and allows the location of the participants to be tracked as the participants traverse the course.

The satellite 180 can relay the signal from the communications vehicle 170 to a television broadcasting facility for subsequent transmission to users via cable, satellite, or terrestrial broadcast, for instance. A digital television transmission may advantageously be used. Note that operators at the television broadcasting facility may also provide data in their transmissions that associates the participants with the camera feeds.

The participants can be associated with the stationary cameras in different ways. In one possible approach, a transceiver analogous to the transceiver 155 is provided near the stationary camera, e.g., camera 120, for detecting the wireless signal from the transmitter 112 carried by the participant, and the transceiver transmits a signal with the identifiers of the participants, and an identifier of the camera 120, to the communications vehicle 170. In another possible approach, the communications vehicle 170 or the television facility correlates the data of a location measuring device, such as the GPS transceiver 160 carried by the vehicle 140, or a GPS transceiver carried by the participant, with the location of a stationary camera. The location of a stationary camera can be determined by taking a one-time reading of the GPS transceiver 160 when the vehicle 160 is next to the camera. Data can be provided to an application for the television viewer that directly associates a participant with a stationary camera. In another possible approach, the application processes the location data for a participant and the location data of a stationary camera to determine which camera is associated with a participant. This can be achieved by determine when the field of view of a camera overlaps or correlates with a participant's location.

The field of view can be assumed to be a specified distance based on characteristics of the camera, or data can be provided by the communications vehicle 170 or the television broadcast facility that designates the field of view by accounting for the camera location and the layout of the course. For example, a camera positioned along a long straight part of the course will have a longer field of view than a camera positioned near a corner or an obstacle such as a building.

Various other approaches may be used to gather the desired data. For example, the cameras 120 and 150, location measuring device 160, weather station 130, and transceiver 155 can communicate directly to the satellite 180.

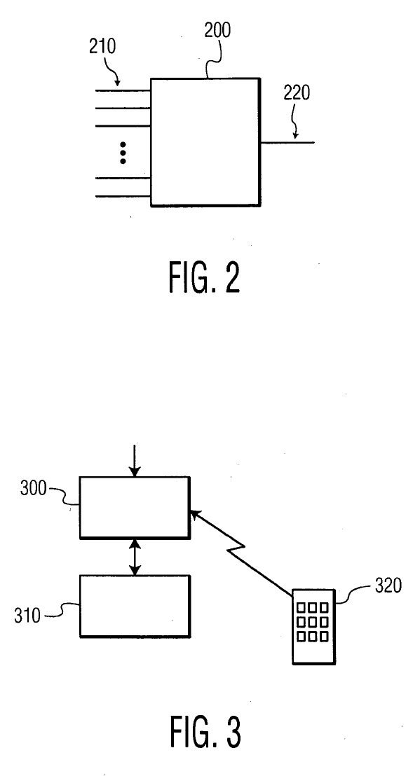

FIG. 2 illustrates a multiplexer for multiplexing data from different camera feeds and additional data such as weather data, location data, and data for associating camera feeds with participants, according to the invention. Other data, such as information regarding features along the course and regarding the participants, for instance, can be provided as well. The data provided by the cameras 120 and 150, location measuring device 160, weather station 130, and transceiver 155 can be input to input lines 210 of a multiplexer 200, such as in the circuitry 176 of the communications vehicle 170, to provide an output signal on an output line 220, for communication to the satellite 180 via the antenna 174. Note that while multiplexing the data is convenient, it is also possible to have the data transmitted via different channels of different communication paths to the viewer. For example, the camera feed data may be multiplexed and transmitted via the satellite 180, while the data from the location measuring device 160, weather station 130, and transceiver 155 can be transmitted to the viewer via a network such as the Internet.

FIG. 3 illustrates a set-top box 300 and a television 310 for running an interactive application for displaying graphics and data from the camera feeds, according to the invention. An interactive television application can be run using executable instructions such as software, firmware and/or micro-code stored at the set-top box, in one possible approach. A memory that stores the instructions may be considered a program storage device. At least one program storage device may tangibly embody the instructions that are executed by at least one processor to achieve the functionality described herein. Additional data for implementing the application can be received in the television broadcast, for example. For instance, the application may generate template displays using locally stored data that are filled in using data provided in the television broadcast, or via another path such as the Internet.

The set-top box 300 may receive a multiplexed signal from a television broadcast facility, based on the multiplexed signal provided by the communications vehicle 170 and the satellite 180, for instance. The signal may include the different camera feeds, weather data for different points along the course, and location data for the participants and the cameras, as discussed previously. Additionally, data directly indicating which participants are associated with which camera can be provided. Or, data can be provided that is processed by the application to determine which participants are associated with which camera. In either case, data for associating the camera feeds with the participants is provided.

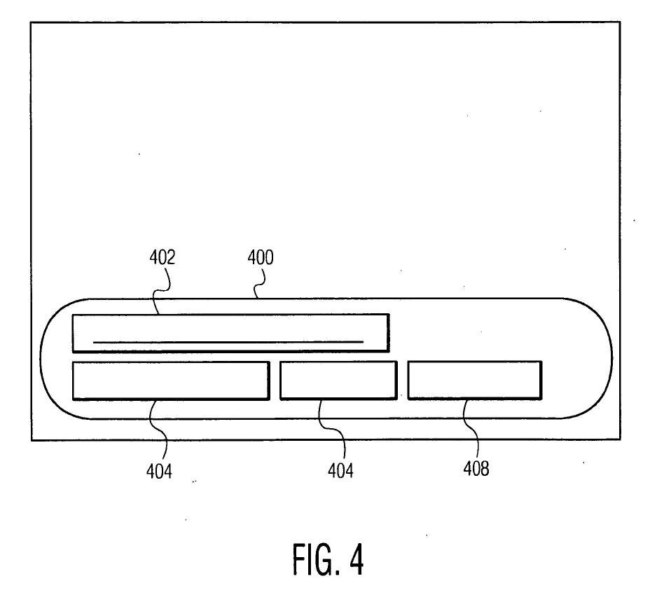

The interactive television application processes the received data to provide various on-screen displays on the television 310, and to respond to commands from the viewer that are entered via a handheld remote control 320, for instance. Other interface techniques such as voice command can be used as well. The viewer may enter a command via the handheld remote control 320 to start the application, causing the menu of FIG. 4 to appear.

Note that the television 310 may be a conventional standalone device or incorporated into a computer or other component. Furthermore, the set-top box 300 is discussed as an example only, as other components, such as a central control of a home media system may be used. Moreover, other inputs, such as an Internet input to the set-top box 300, may be provided.

FIG. 4 illustrates a menu 400 of an interactive television application, according to the invention. The menu 400 may be displayed as on-screen graphic that is overlaid on top of a television broadcast, such as a broadcast of one of the camera feeds of the event. The menu 400 may be provided at the bottom of the screen, for instance, to allow continued viewing of the broadcast content. This is the menu of the interactive application that is attached to the service that is broadcast. Using this menu, the viewer (end user) can open all of the different features of the application using the remote control 320. For example, the remote control 320 may have color-coded buttons to open the different features, and for entering specific settings, such as identifying the participants in which the viewer is interested in following.

The menu 400 includes a title area 402, which reads “Interactive Cycling Application”, a first region 404, which reads “RED: Dynamic profile”, a second region 406, which reads “GREEN: Gaps”, and a third region 408, which reads “BLUE: Weather”. The user can press the appropriate button on the remote control 320 to begin any of these features. Note that different menus can be provided depending on the event type.

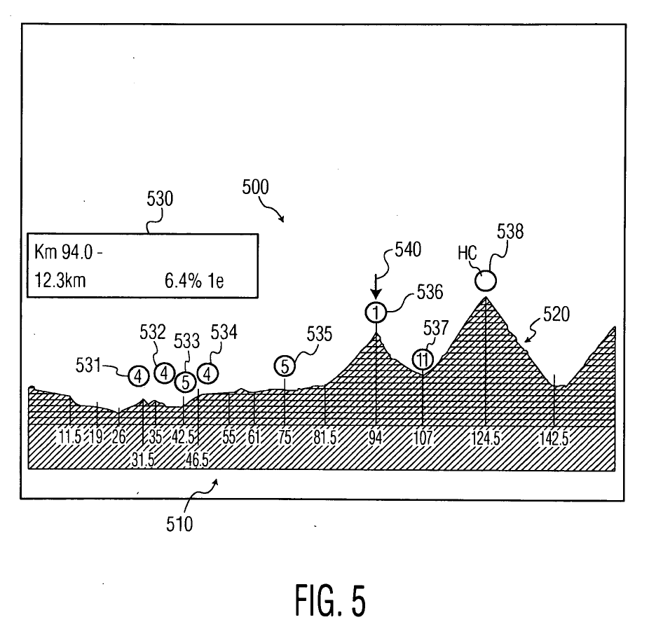

FIG. 5 illustrates a dynamic profile of an interactive television application, according to the invention. The dynamic profile 500 allows the viewer to navigate over different features on the course, such as mountains, difficult corners or other obstacles, rest stations, and the like, and to see detailed information regarding the features. The dynamic profile includes a graphic 510 along an x-axis, which shows the distance of different points along the course in units of kilometers, and a graphic 520 along a y-axis, which shows the height or elevation of different points along the course. The circular icons represent a difficulty of the course. In one possible scheme, a long and steep uphill segment of the course, which is more difficult for the participant, is represented by a lower number then a flat, short segment, which is less difficult. The degree of difficulty may account for other factors as well, such as sharp curves or narrow passages. Icons 531-538 represent conditions along the course. In particular, icons 531, 532 and 534 indicate a low difficulty (level “4”), icons 533 and 535 indicate the terrain is smooth or level (“S”), icon 536 (level “1”) indicates a higher difficulty, icon 537, which is an icon of a fork and knife, denotes a provisioning area where the riders get a bag of food (e.g., during the Tour de France getting food is only allowed at this moment in time within the race,), and icon 538 (“HC”) denotes the highest possible category of mountains that must be climbed. The difficulty can be calculated by the application using the elevation data, for example, by calculating a slope of change in elevation per unit of distance along the course, or can be assigned by an operator at the television broadcast facility or communications vehicle 170, for instance.

Moreover, an icon such as an arrow 540 can be controlled by the viewer using the remote control 320. In particular, the arrow 540 can be positioned over different parts of the course. When the arrow is positioned over one of the circular icons, for instance, a graphic box 530 is displayed that provides further information regarding the identified course feature. As an example, with the arrow 540 positioned over the icon 536, denoting the feature of highest steepness, the graphic 530 reads: “Km 94.0-Co1 d'Aspin, 12.3 km climb at 6.4%-1e Cat”. This indicates that the peak is at the distance of 94 km into the course, and there is a climb at an average grade of 6.4% for 12.3 km leading up to the peak. The geographic location of the peak, Co1 d'Aspin is also provided. “1e Cat” denotes the difficulty of the climb. As mentioned, this type of data can be communicated to the set-top box 300 by the television broadcast facility, in one possibility, to allow the interactive television application running at the set-top box 300 to generate the displays provided herein.

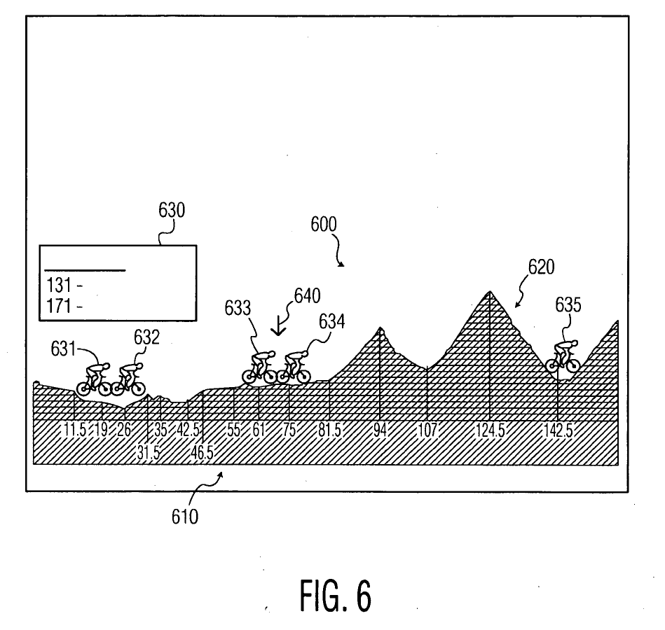

FIG. 6 illustrates a gaps profile of an interactive television application, according to the invention. The gaps profile 600 includes a graphic 610 along an x-axis, which shows the distance of different points along the course in units of kilometers, and a graphic 620 along a y-axis, which shows the height or elevation of different points along the course. In this profile, the locations of the participants as they traverse the course is shown. The profile is updated as the participants progress along the course. The separation distance, or gap, between the participants can also be seen. For example, icons 631, 632, 633, 634 and 635 represent different participants in a cycling event. Note that the icons can vary depending on the event. As with the profile 500, the viewer can move an arrow 640 over an icon to browse over the different participants and obtain further information, from the graphics box 630, regarding the participants.

In the example shown, the arrow 640 is over icons 633 and 634, and the corresponding information regarding the participants in the graphic 630 reads: “Pursuers: 131-ULLRICH Jan, 171 MAYO Iban”. This indicates that the two participants are pursuing the leader, represented by the icon 635. Furthermore, the assigned race numbers and names of the participants are provided. Other, more detailed, information regarding the participants, such as personal biographical information, may also be displayed by the graphic 630. It is also possible for the viewer to access video such as a recorded interview with a participant.

Note that it may be confusing to display icons for a large number of participants, and the viewer may only be interested in tracking the progress of certain participants. To address this, the interactive television application allows the viewer to select one or more participants to follow during the event. For instance, an on-screen window may prompt the viewer to enter the event/race numbers of the desired participants. A menu may display all participants, where the viewer can scroll through the list and selected the desired participants. The viewer may also select to follow one or more teams of participants as well, or groups of participants that are otherwise related. For example, the application may allow the viewer to select participants from a certain country.

Once the viewer selects the participants to follow during the event, when the different views of the application are opened, only information regarding the selected participants, such as their locations along the course, is displayed, in one possible approach. The remaining participants are thus filtered out. In another approach, the information for the selected participants is displayed with an emphasis, e.g., with highlighting or a special color, to distinguish the selected participants from the other participants.

Furthermore, the gaps profile 600 allows the viewer to jump to a video stream in which a designated participant is present. As mentioned earlier, camera feeds from stationary and/or moving cameras can be associated with the participants so that it is known which cameras have a view of which participants. In this way, the user can position the arrow 640 over the icon of one of the participants, and enter a command using the hand held controller 320 to view the video, e.g., camera feed, of the selected participant. The viewer can also select a group of participants to follow, and press a certain key on the handheld remote control to open the video stream associated with that group. The video may be display with the gaps profile 600, including the graphic 630, overlaid.

Note that the viewer may also be provided with the ability to view only portions of the course in an expanded view rather than viewing the entire course at once. Also, the viewer may select to display the course in different rows on the screen such that the end of one row is continued at the start of a next row. Various other possibilities will be apparent to those skilled in the art.

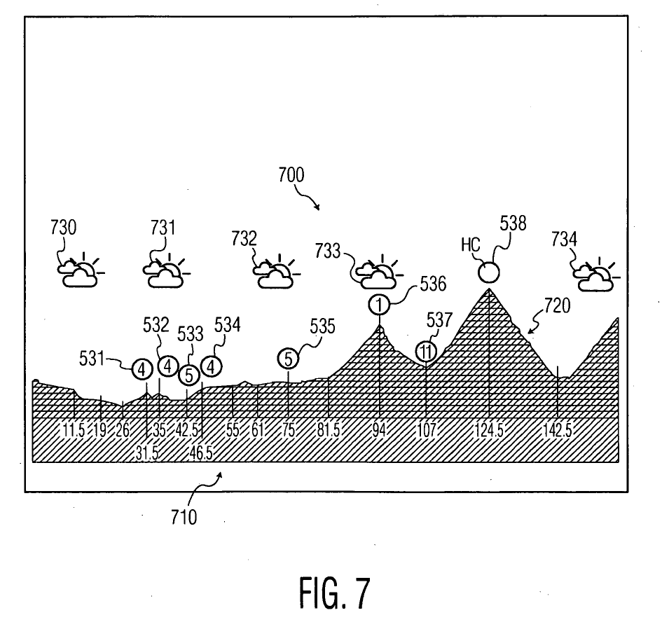

FIG. 7 illustrates a weather profile of an interactive television application, according to the invention. As mentioned, data from weather stations along the course, such as weather station 130 of FIG. 1, can be provided to the interactive television application to generate graphics that indicate the weather conditions at different points along the course. The weather profile 700 includes a graphic 710 along an x-axis, which shows the distance of different points along the course in units of kilometers, and a graphic 720 along a y-axis, which shows the height or elevation of different points along the course. Additional graphics are provided to indicate the weather conditions. For example icons, 730 and 734 indicate mostly cloudy conditions (two dark clouds covering part of the sun), and icons 731, 732 and 733 indicating partly cloudy conditions (one dark cloud and one light cloud covering part of the sun). Graphics, including text, which provide information regarding the other weather conditions, such as temperature, wind speed and direction, humidity, wind chill factor, precipitation, and the like, can also be provided. In one possible approach, the viewer may move an icon such as an arrow over one of the icons 730-734, and enter a command on the handheld remote control to cause a new graphic with further details to appear.

Generally, the profiles 500, 600 and 700 may be displayed as on-screen graphics that are overlaid on top of a television broadcast, such as a broadcast of one of the camera feeds of the participants on the course. The profiles 500, 600 and 700 may be provided at the bottom of the television screen, for instance, or on a separate screen. Moreover, the profiles can be combined in different ways. For example, the weather profile 700 may be displayed with the gaps profile 600.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for providing an application on a television for tracking at least one participant along a course, comprising:
receiving first data at an application indicating locations of different points along the course;
receiving tracking data at the application that is obtained by tracking a location of the at least one participant as the at least one participant traverses the course;
displaying, on the television, via the application, a graphic showing the locations of the different points of the course based on the first data, and showing a location of the at least one participant on the course, based on the tracking data; and
updating the graphic to show changes in the location of the at least one participant as the at least one participant traverses the course.

2. The method of claim 1, further comprising:
receiving second data at the application indicating weather conditions of different points along the course; and
displaying on the television, via the application, based on the second data, and with the graphic showing the locations of the different points, a graphic showing the weather conditions.

3. The method of claim 1, further comprising:
receiving second data at the application indicating an elevation of the different points along the course; and
displaying on the television, via the application, based on the second data, and with the graphic showing the locations of the different points, a graphic showing the elevation of the different points.

4. The method of claim 3, further comprising:
determining a difficulty of different segments along the course based on the second data; and
displaying on the television, via the application, and with the graphic showing the elevation of the different points, a graphic showing the difficulty of the different segments as determined by the determining step.

5. The method of claim 1, further comprising:
receiving second data at the application that provides information regarding points of interest along the course;
receiving a command from a viewer of the television that selects one of the points of interest, via the application; and
displaying on the television, via the application, based on the second data, and responsive to the command, a graphic that provides the information regarding the selected point of interest.

6. The method of claim 1, wherein:
the receiving tracking data comprises receiving tracking data at the application that is obtained by tracking a location of different participants as the different participants traverse the course;
the graphic displayed on the television shows locations of the different participants on the course, based on the tracking data; and
the graphic is updated to show changes in the locations of the different participants as the different participants traverse the course.

7. The method of claim 6, further comprising:
receiving second data at the application that provides information regarding the different participants;
receiving a command from a viewer of the television that selects at least one of the different participants, via the application; and
displaying on the television, via the application, based on the second data, and responsive to the command, a graphic that provides the information regarding the at least one selected participant.

8. The method of claim 1, wherein the receiving tracking data comprises receiving tracking data at the application that is obtained by tracking a location of different participants as the different participants traverse the course, and the method further comprises:
receiving a command from a viewer of the television, via the application, identifying at least one of the participants whose location is to be displayed on the graphic with an emphasis to distinguish the at least one identified participant from other ones of the different participants.

9. The method of claim 1, wherein the receiving tracking data comprises receiving tracking data at the application that is obtained by tracking a location of different participants as the different participants traverse the course, and the method further comprises:
receiving a command from a viewer of the television, via the application, identifying at least one of the participants whose location is to be displayed on the graphic, such that other ones of the participants are filtered out.

10. The method of claim 1, wherein:
the location of the at least one participant is tracked by a location measuring device carried with at least one of the participant and a vehicle that travels with the participant.

11. The method of claim 10, wherein:
the location measuring device comprises a global positioning satellite device.

12. A method for providing an interactive application on a television for viewing participants along a course, comprising:
receiving, at the interactive application, data from camera feeds of the participants at different points along the course as the participants traverse the course, and data for associating the camera feeds with the participants;
receiving a command from a viewer of the television, via the interactive application, that identifies at least one of the participants;
selecting, via the interactive application, at least one of the camera feeds associated with the at least one identified participant, responsive to the command, using the data for associating the camera feeds with the participants; and
playing the at least one selected camera feed on the television.

13. The method of claim 12, wherein the camera feeds comprise moving camera feeds that move with the participants as the participants traverse the course.

14. The method of claim 12, wherein the camera feeds comprise camera feeds at stationary locations along the course.

15. The method of claim 12, further comprising:
receiving tracking data at the interactive application that is obtained by tracking locations of the participants as the participants traverse the course; and
providing a graphic on the television, via the interactive application, showing the respective locations of the participants on the course, based on the tracking data.

16. A method for providing an interactive application on a television for tracking participants along a course, comprising:
receiving tracking data at the interactive application that is obtained by tracking locations of the participants as the participants traverse the course;
displaying, on the television, via the interactive application, a graphic showing locations of the participants on the course, based on the tracking data;
updating the graphic to show changes in the locations of the participants as the participants traverse the course;
receiving, at the interactive application, data from camera feeds of the participants as the participants traverse the course, and data for associating the camera feeds with the participants;
receiving a command from a viewer of the television, via the interactive application, that identifies at least one of the participants;
selecting, via the interactive application, at least one of the camera feeds that has a view of the at least one identified participant, responsive to the command, using the data for associating the camera feeds with the participants; and
playing the at least one selected camera feed on the television together with the graphic.

17. At least one program storage device tangibly embodying instructions that are executable by at least one processor to provide an application on a television for tracking at least one participant along a course, the method comprising:
receiving first data indicating locations of different points along the course;
receiving tracking data that is obtained by tracking a location of the at least one participant as the at least one participant traverses the course;
displaying, on the television, a graphic showing the locations of the different points of the course based on the first data, and showing a location of the at least one participant on the course, based on the tracking data; and
updating the graphic to show changes in the location of the at least one participant as the at least one participant traverses the course.

18. At least one program storage device tangibly embodying instructions that are executable by at least one processor to provide an application on a television for viewing participants along a course, the method comprising:
receiving data from camera feeds of the participants at different points along the course as the participants traverse the course, and data for associating the camera feeds with the participants;
receiving a command from a viewer of the television, via the interactive application, that identifies at least one of the participants;
selecting at least one of the camera feeds associated with the at least one identified participant, responsive to the command, using the data for associating the camera feeds with the participants; and
playing the at least one selected camera feed on the television.
